(19) United States
(12) Patent Application Publication
(10) Pub. No.: US 2015/0074690 A1
(43) Pub. Date: Mar. 12, 2015

(54) METHOD AND APPARATUS FOR PROVIDING APPLICATION

(71) Applicant: Samsung Electronics Co., Ltd., Gyeonggi-do (KR)

(72) Inventors: Jihyun PARK, Gyeonggi-do (KR); Hyunsoo KIM, Gyeonggi-do (KR); Kyunghee LEE, Gyeonggi-do (KR); Chihyun CHO, Gyeonggi-do (KR); Changryong HEO, Gyeonggi-do (KR)

(21) Appl. No.: 14/478,186

(22) Filed: Sep. 5, 2014

(30) Foreign Application Priority Data
Sep. 9, 2013 (KR) 10-2013-0108011

(51) Int. Cl. G06F 9/54

(52) U.S. Cl. CPC G06F 9/541
USPC 719/328

(57) ABSTRACT

A method and apparatus for providing an application includes providing a first application through a display unit operatively coupled to an electronic device. A user input is obtained that is related to the first application. A second application is identified for execution in an external device for the electronic device based on the user input. Data is generated that is provided to the external device from the electronic device based on at least one of the first application or the second application.

### CLAIM OF PRIORITY

This application claims the benefit under 35 U.S.C. §119(a) from Korean patent application Serial No. 10-2013-0108011, filed on Sep. 9, 2013 in the Korean Intellectual Property Office and the entire disclosure of which is hereby incorporated by reference.

### BACKGROUND

1. Field of the Disclosure

The present disclosure relates to an electronic device, and more particularly, to an apparatus for providing an application and a method using the same.

2. Description of the Related Art

An electronic device may be configured to provide various applications that may include, for example, an application for sending and receiving a message through a network, an application for obtaining an image through a camera, an application which provides a voice communication, a video play application, an application receiving a broadcasting signal to provide a video or audio program, etc.

Further, the electronic device may be implemented in various types that may include a floor type electronic device e.g., a TV having a large display, a portable electronic device e.g., a portable-sized smart phone, or a wearable electronic device wearable for user's body e.g., a watch, eyeglasses, clothing, or a belt, etc.

Electronic devices such as the types described above may provide various applications, and each of the various applications may have various technical attributes. For example, in the case of an application for sending and receiving a message through a network, a convenient input tool provided by the electronic device may be a technical attribute.

In addition, in the case of an application for obtaining an image through a camera, a performance of the camera included in the electronic device may be a technical attribute. Moreover, in the case of an application that provides a voice communications, a performance of a microphone or a speaker included in the electronic device may be a technical attribute.

Moreover, in the case of a video player application, a performance of display that the electronic device may provide may be a technical attribute. Alternatively, in the case of an application receiving a broadcasting signal to watch a video or audio program, a strength of broadcast signal that the electronic device may receive may be considered a technical attribute.

However, since an application is provided to a user by using a single electronic device, various technical attributes of the application may not be considered. Thus, even though user uses (e.g., hold or wear) various electronic devices simultaneously, the electronic device suitable for a given application may not be used, such that the efficiency of use of the electronic device may be significantly lowered.

### SUMMARY

Various embodiments of the present disclosure provide a method and apparatus for increasing an efficiency of utilization of a plurality of electronic devices and installed application(s) thereof. According to another aspect of the invention, various embodiments of the present disclosure may execute (e.g., provide to user) various applications requested to be executed by a given electronic device through an electronic device suitable for respective technical attributes.

In accordance with an aspect of the present disclosure, a method may include: providing a first application through a display unit operatively coupled to an electronic device; obtaining a user input related to the first application; identifying a second application to be executed in an external device for the electronic device based on the user input; and generating data to be provided to the external device from the electronic device based on at least one of the first application or the second application.

In accordance with another aspect of the present disclosure, an electronic device includes: a providing module to display a first application to be executed in an electronic device; an acquisition module to obtain a user input corresponding to the providing module; an identification module to identify at least one of a second application to be executed in an external device for the electronic device or a function of the second application based on the user input; and a generation module to generate data to be provided to the external device based on at least one of the first application, the second application, or the function.

In accordance with another aspect of the present disclosure, there is provided a computer-readable recording medium comprised of non-transitory storage having recorded a program for obtaining a user input related to a first application provided through a display unit operatively coupled to an electronic device; identifying a second application to be executed in an external device for the electronic device based on the user input; and generating data to be provided to the external device from the electronic device based on at least one of the first application or the second application.

### BRIEF DESCRIPTION OF THE DRAWINGS

The above features and advantages of the present disclosure will become more apparent to a person of ordinary skill in the art from the following detailed description in conjunction with the accompanying drawings, in which:

FIG. 1 shows an apparatus and a system for providing an application according to various embodiments of the present disclosure;

FIG. 2 illustrates an non-limiting example of a user interface provided by an electronic device according to various embodiments of the present disclosure;

FIG. 3 illustrates a user interface provided by an electronic device during a selection of certain application information according to various embodiments of the present disclosure;

FIG. 4 illustrates a user interface provided by an electronic device after selection of the application information according to various embodiments of the present disclosure;

FIG. 5 illustrates a user interface screen showing information regarding various electronic devices provided by an electronic device according to various embodiments of the present disclosure;

FIG. 6 is a flowchart providing an operational illustration of a method for providing an application through an electronic device according to various embodiments of the present disclosure;

FIG. 7 illustrates a block diagram including certain items stored on a memory for an electronic device according to various embodiments of the present disclosure; and

FIG. 8 illustrates a block diagram of a certain hardware according to various embodiments of the present disclosure.

### DETAILED DESCRIPTION

Embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present disclosure by a person of ordinary skill in the art.

An artisan is to understand that the singular forms “a,” “an,” and “the” include plural references unless the context clearly dictates otherwise. Thus, for example, reference to “a component surface” includes reference to one or more of such surfaces.

By the term “substantially” an artisan is to understand that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to the present disclosure may be embodied as or include a device including a communication function. For example, the electronic device may include a smartphone, a tablet personal computer (tablet PC), a mobile phone, a video phone, an e-book reader, a desktop personal computer (desktop PC), a laptop personal computer (laptop PC), a netbook computer, a personal digital assistant (PDA), a portable multimedia player (PMP), a MP3 player, a mobile medical equipment, a camera, and a wearable device (e.g., at least one of a head-mounted-device (HMD) like e-glasses, an electronic clothe, an electronic bracelet, an electronic necklace, an electronic accessory, appcessory, or a smart watch).

According to various embodiments of the present disclosure, the electronic device may be embodied as or may include a smart home appliance that has a communication function. The smart home appliance may include, for instance, at least one of a television, a digital video disk (DVD) player, an audio equipment, a refrigerator, an air conditioner, a vacuum cleaner, an oven, a microwave, a washing machine, an air purifier, a set-top box, a TV box (e.g., Samsung HomeSync™, Apple TV™, or Google TV™), a game console, an electronic dictionary, an electronic key, a camcorder, or an electronic frame, just to mention some non-limiting examples.

According to various embodiments of the present disclosure, the electronic device may be embodied as or may include at least one of various medical devices (e.g., magnetic resonance angiography (MRA), magnetic resonance imaging (MRI), computed tomography (CT), a camera, an ultrasonic equipment, etc.), just to name some non-limiting examples. In addition, the electronic device may be embodied as or include a navigation device, a global positioning system receiver (GPS receiver), an event data recorder (EDR), a flight data recorder (FDR), a vehicle infotainment device, a marine electronic equipment (e.g., a marine navigation system and a gyro compass, etc.), an avionics, or a security device.

According to various embodiments of the present disclosure, the electronic device may be embodied as or may include at least one of part of furniture or building/structure including a communication function, an electronic board, an electronic signature receiving device, a projector, or various measurement devices (e.g., water, electricity, gas, or a radio wave, etc.).

The electronic device according to the present disclosure may be embodied as or may include a combination of one or more of the aforementioned various devices. Further, it is apparent to those skilled in the art that the electronic device according to the present disclosure is not limited to the above-described devices. Hereinafter, an electronic device according to various embodiments of the present disclosure is illustrated with reference to accompanying drawings. The term ‘user’ associated with the description of various embodiments may include a person who uses an electronic device or an apparatus (e.g., an artificial intelligence electronic device) that uses an electronic device.

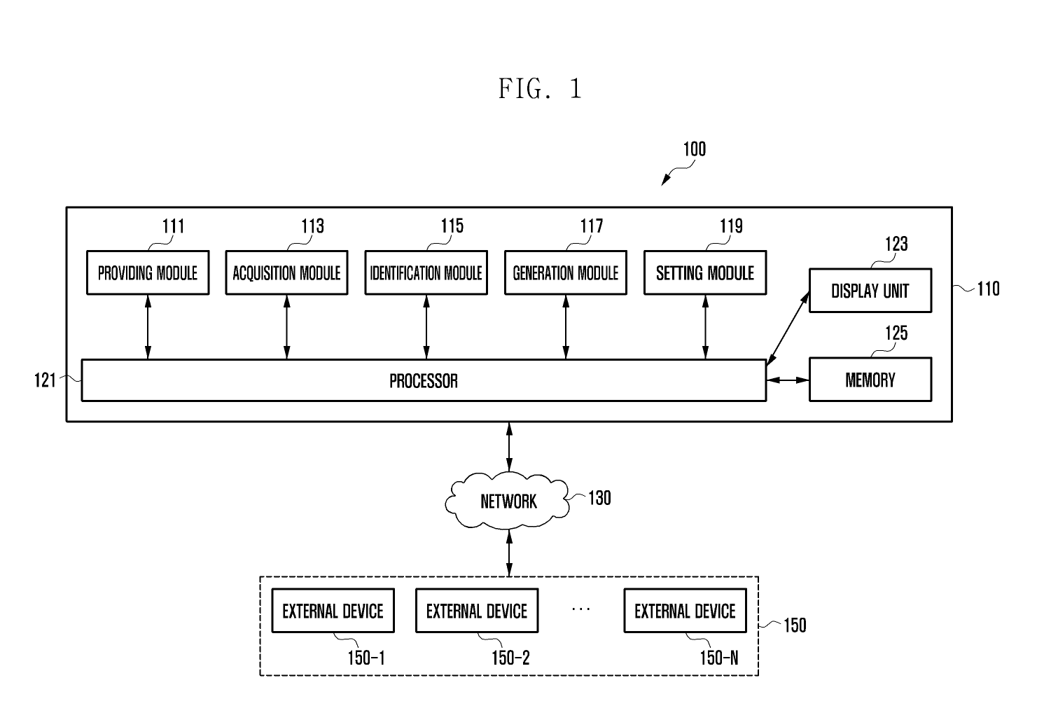

FIG. 1 illustrates an apparatus and a system 100 for providing an application according to various embodiments of the present disclosure.

According to one embodiment of the present disclosure, the system 100 for providing an application may include an electronic device 110, a network 130, and at least one external device 150 which can communicate with the electronic device 110 via the network 130. The electronic device 110 (e.g., a smart watch) may control at least one external device 150 through a network 130 (e.g., a short range communication e.g., Internet or a near field communication (NFC) or a Bluetooth low energy (BLE), etc.). For example, the electronic device 110 may provide a data related to an application to at least one external device 150 through the network 130 so that the at least one external device 150 may process at least some functions of the application which is scheduled to execute or is being executed in the electronic device 110. The external device 150 may process functions of an application in sequence with the electronic device 110 or in lieu of being processed by the electronic device 110.

The at least one external device 150 may include a first external device to an N-th external device (150-1 to 150-N, N is a natural number which is 1 or more). The at least one external device 150 may send and receive data with the electronic device 110 through the network 130. The at least one external device 150 may provide an application or a function thereof based on the data received from the electronic device 150. For example, when a first external device 150-1 (e.g., a tablet device) of the at least one external device 150 receives data requesting an image editing application from the electronic device 110, the first external device 150-1 may provide the image editing application to the electronic device 110.

The network 130 may provide a path to transmit and receive data between the electronic device 110 and the at least one external device 150. The network 130 may be configured by a diverse type of network topology. For example, the network 130 may be constructed of various types such as a bus topology, a star topology, a ring topology, a tree topology, or a mesh topology. The network 130 may include a wired network (e.g., a network between devices through a cable) or a wireless network (e.g., a Bluetooth, or a Long term Evolution (LTE) network).

According to one embodiment of the present disclosure, the electronic device 110 may include a providing module 111, an acquisition module 113, an identification module 115, a generation module 117, a setting module 119, a processor 121, a display unit 123, and a memory 125. An artisan should understand and appreciate that the aforementioned modules as well as other modules in the invention are not software per se or pure software and include hardware circuitry configured for operation. In addition, all of the modules can be considered sub-processors, and thus the items shown in FIG. can be referred to as a providing sub-processor 111, an acquisition sub-processor 113, an identification sub-processor 115, a generation sub-processor 117, a setting sub-processor 119, a main processor 121.

The providing module 111 may provide information related to the application (hereinafter, for convenience of explanation, referred to as application of interest) that can be executed in the electronic device 110 to the display unit 123. For example, the providing module 111 may be configured to provide information related to the application of interest to the display unit 123 so that the display unit 123 may display (e.g., provide to user) information related to the application of interest. The application of interest may be, for example, the application that the electronic device 110 is currently executing or going to execute in the future or the function thereof. The application of interest may be one, or may be two or more.

According to one embodiment of the present disclosure, the providing module 111 may be configured to provide the display unit 123 with information related to at least one application or the function thereof (hereinafter, for convenience of description, referred to as a candidate application) that can be executed (e.g., currently being executed or going to be executed) in at least one external device 150 in relation to the application of interest, based on a user input. For example, when an alarm application is being executed or can be executed in a first external device (e.g., external device 150-1) of the at least one external device 150, the providing module 111 may provide information on the alarm application or on the function related to the alarm application to the display unit 123. Further, when a message application is being executed or can be executed in a second external device (e.g., external device 150-2), the providing module 111 may provide information on the message application or on the function related to the message application to the display unit 123 so that the display unit 123 may display corresponding information.

According to one embodiment of the present disclosure, the providing module 111 may control the display unit 123 to provide (e.g., display) information related to other candidate applications according to an attribute of a user input obtained with respect to the application of interest. The attribute of the user input may be configured of a type, a direction, a shape, an intensity, and a duration time of corresponding input, or a combination thereof. For example, the type of the user input may be a hovering input method, a touch input method, and a sound input method, or a combination thereof, just to name a few non-limiting examples. The direction of the user input may mean a movement direction of the user input, and may be, for example, a left, a right, an up, a down, and a diagonal direction, or a combination thereof. The shape of the user input may be a specific shape corresponding to the user input, and may be, for example, a circle, a polygon (e.g., a triangle, a rectangle, or a pentagon), a character (e.g., an alphabet), and a special symbol (e.g., an asterisk, an exclamation point, or a question mark), or a combination thereof.

The duration time of the user input may indicate, for example, a time during when the user input is being continuously input. For example, the duration time of the user input may be previously defined within a first range to a third range, and the attribute of the user input may be identified based on the duration time of the user input. For example, assuming that the user input corresponding to the first range has a time ranging from 0 or more second to less than 1 second, the second range may have a time ranging from 1 or more seconds to less than 3 seconds, and a third range may have a time ranging from 3 or more seconds to less than 6 seconds, just to name some non-limiting examples. The range for the duration time of the user input may be variously implemented according to each attribute of a designer or an electronic device.

The intensity (e.g., pressure) of the user input may be divided into, for example, a predefined high, middle, or low intensity, or the like. Such definition may be previously performed in a similar way to a time of user input. According to various embodiments of the present disclosure, the attributes of two or more of the type, the direction, the shape, the intensity or the duration time of the user input that may be used in combination.

The providing module 111 may provide, as mentioned above, based on the different attributes of the user input, information related to candidate application which is previously set (e.g., mapped) for each attribute to display unit 123. For example, the providing module 111 may provide information related to a candidate application based on at least one of a user input selecting a provided menu of the application of interest (e.g., a share button) or a user input related to the application of interest (e.g., a drag input). According to one embodiment of the present disclosure, when a specific application or a function thereof (e.g., a message application or its arrival notification function) is provided as the application of interest, the providing module 111 may provide the information related to the candidate application as a list, an image, other suitable form, or a combination thereof when there is no user input.

According to another embodiment of the present disclosure, the providing module 111 may provide information on at least one external device 150 operatively coupled to the electronic device 110 through, for example, the display unit 123. For example, the providing module 111 may control the display unit 123 to differently display a content, a volume, a display location, or a display method of information which is provided with respect to the at least one external device 150, according to the attribute of user input or attribute information (e.g., location information or signal strength information) of the at least one external device 150. For example, when the at least one external device 150 is located in an eastward direction of the electronic device 110, the providing module 111 may control to display information related to a corresponding external device in an area corresponding to the eastward direction of the display unit 123. It should be understood that the direction is relative to the display of the electronic device, and not, for example, due East, etc.

Similarly, when the at least one external device 150 is located in a southward direction of the electronic device 110, the providing module 111 may control to display information related to a corresponding external device in an area corresponding to the southward direction of the display unit 123. Additionally or alternatively, when the at least one external device 150 is located in a southward direction of the electronic device 110, the providing module 111 may control to display information (e.g., information related to a candidate application) related to an application that may be provided from a pertinent external device or a function thereof in an area corresponding to the southward direction of the display unit 123. It is also possible that the external device 150 could be in a southwest, northwest, northeast, or southeast direction external.

According to one embodiment of the present disclosure, the providing module 111 may provide only information on a candidate application to be executed in at least one external device 150 with respect to the application of interest to the display unit 123, and may also provide information on external device related to candidate application together with the information related to candidate application. The information on candidate application or a function thereof, or the information on a relevant external device may be provided in a form of, for example, a list, an image, or any other suitable form through the display unit 123.

According to one embodiment of the present disclosure, the providing module 111 may control to provide the information on the candidate application or at least one relevant external device 150 at least in a X-axis or a Y-axis direction of the display unit 123. For example, if the X-axis direction corresponds to one side of display unit 123, the Y-axis direction may be a direction orthogonal to the one side of the display unit 123. The providing module 111 may control to display information in a direction (e.g., a diagonal direction of 10 degrees, 20 degrees, 45 degrees or 60 degrees, or the like) forming a specific angle between the X-axis direction and the Y-axis direction in addition to the X-axis or Y-axis direction, or in a direction of Z-axis (e.g., a three-dimensional image or a hologram).

With continued reference to FIG. 1, the acquisition module 113 may obtain user input related to the application of interest. According to one embodiment of the present disclosure, the acquisition module 113 may obtain the user input related to the application of interest from, for example, at least one of an area of (e.g., on) the application of interest, its neighboring area (e.g., under, over, or around, etc.), a specified area related to the application of interest, or an area displaying an application (e.g., candidate application) related to the application of interest.

According to one embodiment of the present disclosure, the acquisition module 113 may obtain a gesture for moving at least a part of the application of interest (e.g., a partial area of an image corresponding to application of interest or a function thereof) or based on the movement of an input device (e.g., an electronic pen) as a user input. For example, the acquisition module 113 may obtain a user input through a device (e.g., a touch screen) which is included in the display unit 123. The acquisition module 113 may obtain only one user input, and may obtain two or more user inputs simultaneously or subsequently depending on an input entered by the user.

The identification module 115, for example, based on at least the user input, may identify an application (hereinafter, for convenience of explanation, a target application) which will be executed in at least one external device 150 in relation to the application of interest or a function thereof. According to one embodiment of the present disclosure, the identification module 115 may identify a target application based on an attribute of user input such as a type, a direction, a shape, an intensity, a speed, or time, or a combination thereof.

For example, when a time of the user input (e.g., a first attribute) belongs to a specified range (e.g., a time of 1 second or more and less than two seconds), the identification module 115 may identify a selected candidate application as a target application, depending on an additional user input selecting at least one of information related to one or more candidate applications which are displayed through the display unit 123. The candidate application(s) may be an application(s) that can be executed in a given external device (e.g., external device 150-1), or a group of applications that can be executed in one corresponding external device among a plurality of external devices (e.g., an external device 150-1, 150-2).

According to one embodiment of the present disclosure, the identification module 115 may identify a target application corresponding to an application of interest, without displaying information related to one or more applications (e.g., a candidate application) other than the application of interest additionally. However, the identification module 115 may also identify a target application corresponding to an application of interest without obtaining a user input regarding any displayed information related to one or more applications.

For example, the identification module 115 may designate automatically at least one application specified to correspond to a first range of a first attribute as a target application without any additional user input, based on a determination that the first attribute (e.g., a duration time) of the user input which is obtained in relation with application of interest belongs to a specified range (e.g., a first range).

According to one embodiment of the present disclosure, the attribute of the user input and a corresponding application (e.g., a candidate application, or a target application) may have been previously specified (e.g., mapped) by, for example, the user through, for example, the setting module 119 which will be subsequently described herein. According to one embodiment of the present disclosure, additionally or alternatively, the attribute of a user input, or an application corresponding to a specific value, may be identified dynamically based on context awareness information such as a usage state of the application (e.g., a frequency or the last time used), a current time, or a location or type of the electronic device 110 or at least one external device 150 which will execute the target application.

According to one embodiment of the present disclosure, the identification module 115 may also be configured to identify whether the user input is a specified (e.g., mapped) gesture. Further, if the user input is a specified gesture, the identification module 115 may identify an application which is specified (e.g., mapped) to correspond to the gesture as a target application. For example, a social network service (SNS) application may be specified as a target application by using a gesture waving a hand from side to side. In this exemplary case, when the gesture waving a hand from side to side is obtained as a user input related to application of interest, the identification module 115 may identify the SNS application as a target application for the application of interest. Similarly, a mail application may be specified to a gesture which draws @. In this case, when the gesture corresponding to @ is obtained as a user input related to application of interest, the identification module 115 may identify the mail application as a target application for the application of interest.

According to one embodiment of the present disclosure, the identification module 115 may identify the direction of movement of the user input in relation to an application of interest. Further, the identification module 115 may identify a target application corresponding to an application of interest with reference to information regarding one or more applications (e.g., a candidate application) which are provided according to the direction of movement of the user input. For example, when the user input moves in one certain direction (e.g., a direction in which a value of x-axis of a display unit 123 increases or decreases) with respect to the electronic device 110, an application group (e.g., a first application group) including at least a message application (e.g., a third application) or information (e.g., information related to candidate application) related to each application of the group may provided.

Similarly, the user input may move in another certain direction (e.g., a direction in which a value of y-axis of a display unit 123 increases or decreases) with respect to the electronic device 110 or in the same direction as the user input which is previously (e.g., immediately before) detected. In such a case, information related to, for example, another application group (e.g., a second application group) including at least video call application (e.g., the fourth application) or information of each application of the group may be provided. The identification module 115 may identify a selected application(s) as a target application, depending on the user input to select the third application or the fourth application, or at least one other application of the first application group or the second application group.

The application of interest and the candidate application may be the same type of application (e.g., a message application), or may be a different type of application (e.g., the application of interest is a notification application, and the candidate application is a message application). According to one embodiment of the present disclosure, the candidate application may be an entirety of a given application (e.g., an entire message application), or may include only a part of function of the given application (e.g., a reply function of message application).

According to one embodiment of the present disclosure, the identification module 115 may select one or more external devices (e.g., external device 150-1) from among at least one external device 150 based on the user input as a device to provide a target application. For example, when the user inputs a selection, in response at least one among information related to at least one external device 150 indicated in the providing module 111 is obtained, and the identification module 115 may identify the external device corresponding to the selected information as a device to provide the target application corresponding to the application of interest. According to one embodiment of the present disclosure, for example, based on a user input, the identification module 115 may identify the electronic device 110 as a device for executing the target application additionally or instead of the at least one external device 150.

Additionally or alternatively, the identification module 115 may select an external device to provide (e.g., execute) a target application corresponding to application of interest based on a user input for the application of interest, without displaying information related to at least one external device 150, or without obtaining a user input to select the displayed at least one information related to at least one external device 150. According to one embodiment of the present disclosure, the identification module 115 may select an external device to execute a target application based on attributes such as a type, a direction, a shape, an intensity, a speed, or a time of an application of interest or a user input related to a partial function of the application of interest.

For example, when a the user input movement is in a first direction (e.g., a direction in which a value of x-axis of a display unit 123 increases), in response the identification module 115 may identify at least one external device 150 (e.g., external device 150-1) which is specified to correspond to the first direction as an external device to execute the target application. Similarly, when the user input movement is in a second direction (e.g., a direction in which a value of y-axis of a display unit 123 increases), the identification module 115 may identify at least one external device 150 (e.g., external device 150-2) which is specified to correspond to the second direction as an external device to execute the target application.

According to one embodiment of the present disclosure, a corresponding relationship between a given attribute of a user input and an external device for executing a target application may have been previously specified by, for example, the user through the setting module 119 (which will be subsequently described herein). According to one embodiment of the present disclosure, additionally or alternatively, a target application corresponding to the attribute of the user input or its specific value may be identified dynamically based on the context awareness information such as a usage state of the target application (e.g., a usage frequency or the last time used), a current time, or a location or type of the electronic device 110 or at least one external device 150 which will execute the target application.

According to one embodiment of the present disclosure, when a plurality of user inputs exist, there may be a plurality of external devices corresponding to respective directions, or there may be only the external device corresponding to a certain direction that is identified as an external device to execute the target application. The identification module 115 may identify external device to execute the target application based on an intensity, a duration time, or a type as well as the direction that the user input moves. According to one embodiment of the present disclosure, the identification module 115 may identify a target application corresponding to an application of interest (or its partial function), or an external device to execute the target application simultaneously, subsequently, or in a different order. According to one embodiment of the present disclosure, when the target application corresponding to the application of interest is identified, information related to at least one external device 150 for executing the target application may be displayed through, for example, the display unit 123. When at least one information related to the displayed external device is selected, the identification module 115 may identify the selected external device as an external device in which the target application is to be executed. For example, when the user input moves in a first direction, at least part of a first application (e.g., application of interest) in the first direction is obtained, and the identification module 115 may identify the application specified to correspond to the first direction as being a target application. When the external device in which target application is to be executed is not set, the providing module 111 may provide information related to the at least one external device 150 in which the target application is able to be executed. When a user input selection of is obtained of at least one of the displayed information related to an external device, the identification module 115 may identify the selected external device as being the particular external device in which target application is to be executed.

According to various embodiments of the present disclosure, the identification module 115 may identify the particular external device in which the target application is to be executed and to identify the target application. For example, when the user input movement to a first area is obtained that is associated with at least part of a first application (e.g., application of interest), the identification module 115 may identify a first external device 150-1 specified to correspond to the first area as the particular external device in which the target application is to be executed. Further, the providing module 111 may provide relevant information so that information related to message application and information related to a video call application may be displayed through the display unit 123 as information related to candidate application which can be executed in the first external device 150-1. When the user input of select information is obtained that is related to the video call application from among information related to the displayed candidate application, the identification module 115 may identify the video call application as a target application.

With continued reference to FIG. 1, the generation module 117 may generate data provided from the electronic device 110 to an external device (e.g., at least one external device 150) in which the target application is to be executed based on at least one of the application of interest, or the target application corresponding to the application of interest. According to one embodiment of the present disclosure, the generation module 117 may generate data including information related to a function which was being executed, so that a function (e.g., information provision or a call connection, etc.) which was being executed by application of interest or another related function may be processed subsequently through a target application.

For example, the generation module 117 may include at least one of information related to a function of an application of interest (e.g., context information of Android operating system), information related to a file (e.g., message, image, document) that was being processed in the application of interest, information related to an attribute of the application of interest (e.g., information written in a manifest file (e.g., a package name)), or information related to an operation to be executed in a target application corresponding to the application of interest, in data.

For example, the electronic device 110 may provide a message through a message application (e.g., application of interest) based on an Android operating system. A reply creation function for the provided message may be identified as a target application to be executed in the external device 150-1, based on a user input related to the message application. In this case, the generation module 117 may generate data including at least one of context information related to operation of the message application, information related to a file being processed by the message application, attribute information of the message application, or an instruction requesting the reply creation function. According to one embodiment of the present disclosure, the instruction may include attribute information (e.g., a package name corresponding to the reply creation function (e.g., com.sec.message), component information (e.g., Activity), or an identifier (e.g., ApplicationID_{—}01)) that explicitly designates the reply creation function (e.g., a target application), in data.

Additionally or alternatively, the instruction may include attribute information (e.g., Intent.Operation_Message.reply) implicitly requesting the reply creation function. According to one embodiment of the present disclosure, the electronic device 110 (e.g., a generation module 117) may transmit the generated data to at least one external device 150 which is to execute the target application (e.g., a reply creation function). At least one external device 150 may execute the target application based on the received data. Additionally, at least one external device 150 may send an execution result based on the received data (e.g., a processing result of target application) to the electronic device 110. The electronic device 110 may additionally provide at least one application based on the received result. According to one embodiment of the present disclosure, the generated data (or the execution result of candidate application) may be transmitted or received between the electronic device 110 and at least one external device 150 through, for example, the network 130 (e.g., a short range communication such as NFC or BLE).

For example, the electronic device 110 may provide a first image through an image viewer application (e.g., an application of interest). Based on a user input to move the image viewer application rightward, an image editing function executable (e.g., installed) in the external device 150-1 may be identified as a target application for the image viewer application. The electronic device 110 may generate data (e.g., data including a first image and an instruction) requesting the image editing function to be transmitted to the external device 150-1. The external device 150-1 may provide image editing function based on the received data. Further, the external device 150-1 may send processing information including a second image generated as a result of editing the first image through the image editing function. The electronic device 110 may provide the second image through the image viewer application or another application (e.g., message application or e-mail application) by using the received information.

The setting module 119 may set a corresponding relation (e.g., mapping information) between a candidate application, a target application, or at least one external device 150 and a user input. According to one embodiment of the present disclosure, the setting module 119 may set a candidate application(s), a target application, or at least one external device 150 corresponding to user input (e.g., attribute information of the user input). For example, the setting module 119 may set a message application as the candidate application corresponding to user input which moves at least part of interest of application to a first area (e.g., one axis of display unit 123) of the electronic device 110. Similarly, the setting module 119 may set a first external device (e.g., external device 150-1) as an external device corresponding to a user input which moves at least part of the interest of an application to the first area or a second area (e.g., another axis of display unit 123).

Additionally or alternatively, the setting module 119 may identify the user input (or attribute of the user input) respectively corresponding to attribute information of at least one external device 150. According to one embodiment of the present disclosure, the setting module 119 may obtain location information as attribute information for each of at least part of the external device from among at least one external device 150. For example, the first external device (e.g., external device 150-1) may be located on the wrist of a user of the electronic device 110, and the second external device (e.g., external device 150-2) may be located in a different space (e.g., electronic device 110 may be located in living room, and second external device may be located in kitchen) from the electronic device 110. In this case, the setting module 119 may obtain location information including wrist and kitchen as location information for each of first external device and second external device.

According to one embodiment of the present disclosure, the setting module 119 may obtain location information of at least one external device 150 through at least one sensor module (e.g., a camera module, a magnet module, or an infrared module) of the electronic device 110. Additionally or alternatively, the setting module 119 may receive the location information from at least one external device 150 through, for example, the network 130.

According to one embodiment of the present disclosure, the setting module 119 may set an attribute of a corresponding user input based on attribute information (e.g., location information) of each of at least one external device 150. For example, the setting module 119 may set a user gesture which moves in an upper rightward direction on the display unit 123 as the attribute of user input corresponding to the first external device (e.g., external device 150-1) which is located on the wrist of the user. Similarly, the setting module 119 may set a user gesture which moves in a leftward direction on the display unit 123 as the attribute of user input corresponding to the second external device (e.g., external device 150-2) which is located in the kitchen. The movement direction (or gesture) was illustrated as attribute of user input, but the setting module 119 may have been previously set information related to at least one external device 150 by using another attribute (e.g., intensity, type of user input, etc.).

According to one embodiment of the present disclosure, the setting module 119 may set a display area of information related to, for example, a corresponding external device displayed on the display unit 123 based on the attribute information (e.g., location information) of each of at least one external device 150. For example, when a first external device (e.g., external device 150-1) is located in an upper right direction of the electronic device 110, the setting module 119 may set an upper right area of the display unit 123 as an area that provides information related to the first external device. Similarly, when a second external device (e.g., external device 150-2) is located in an upper left direction of the providing module 111, the setting module 119 may set an upper left area of the display unit 123 as an area that provides information related to the second external device (e.g., external device 150-2). In this case, the providing module 111 may display information related to an external device corresponding to the set display area.

According to one embodiment of the present disclosure, when location information of at least one external device 150 is changed, or a direction or location information of the electronic device 110 is changed, the setting module 119 may change a display area corresponding to the external device 150. For example, when the display unit 123 is rotated counterclockwise, the setting module 119 may change the display area of information corresponding to a first external device 150-1 from a certain area (e.g., a right area) to another area (e.g., a lower area).

Additionally or alternatively, the setting module 119 may set an area corresponding to at least one external device 150, by using other attribute information (e.g., distance information between electronic device 110 and at least one external device 150) of at least one external device 150. According to one embodiment of the present disclosure, the setting module 119 may be set so that an external device having distance information that belongs to a first range may correspond to a first area of the display unit 123 and an external device having distance information that belongs to a second range may correspond to a second area of the display unit 123.

For example, a display area corresponding to a first external device group (e.g., external device 150-1 and external device 150-2), a second external device group (e.g., external device 150-3), and a third external device group (e.g., external device 150-4 and external device 150-5) which have a distance to the electronic device 110 that respectively belong to a range of 0˜1 m (e.g., a first range), a range of 1˜5 m (e.g., a second range), or a range of 5˜20 m (e.g., a third range) may be set as a lower area, a right area, and an upper area of the display unit 123 respectively.

According to one embodiment of the present disclosure, a distance between the electronic device 110 and at least one external device 150 may be identified based on a signal strength (e.g., received signal strength indicator (RSSI)) for a corresponding external device received by the electronic device 110 through the network 130.

According to one embodiment of the present disclosure, the attribute information of each of the at least one external device 150 may include, for example, distance information between the electronic device 110 and a corresponding external device, signal strength information received from a corresponding external device, location information of a corresponding external device, configuration information of a hardware (e.g., a camera module, a speaker module, a display module, or a sensor module, etc.) of a corresponding external device, configuration information of a software (e.g., an operating system, a video play module, an image editing module, or a message transmission module, etc.) executable in a corresponding external device, or state information (e.g., a battery condition of external device) of a corresponding external device, and the like. According to one embodiment of the present disclosure, the setting module 119 may set target application corresponding to each of attribute of user input identically or similarly to a method of setting external device corresponding to each of attribute of user input.

According to one embodiment of the present disclosure, setting information generated by the setting module 119, attribute information of application (e.g., application of interest, candidate application or target application), or attribute information of electronic device 110 or at least one external device 150 may be stored in the memory 125.

According to one embodiment of the present disclosure, the processor module 121 may control a corresponding module to perform operations or functions implemented in at least some modules among the providing module 111, the acquisition module 113, the identification module 115, the generation module 117 or the setting module 119. Further, the processor 121 may receive data from each module, and may provide the received data to other modules (or to the memory 125). For example, the processor 121 may provide data for user input obtained through the acquisition module 113 to the identification module 115.

FIG. 1 illustrates that the processor 121 may transmit and receive data to/from each module, but each module may transmit and receive data mutually. In addition, although respective modules 111, 113, 115, 117, and 119 are shown as a block different from the processor 121, all or part of functions of some module may be included (e.g., embedded) in the processor 121, and the processor 121 may perform a series of operations or functions executed in each module. According to one embodiment of the present disclosure, at least part of the control function of processor 121 may be included in at least one of the modules 111, 113, 115, 117, or 119, or in an additional module. Further, each of the modules 111, 113, 115, 117, and 119 may be implemented in a software, a firmware, a hardware, or a combination thereof, and may perform the same function as a previous function even in combination with another module(s).

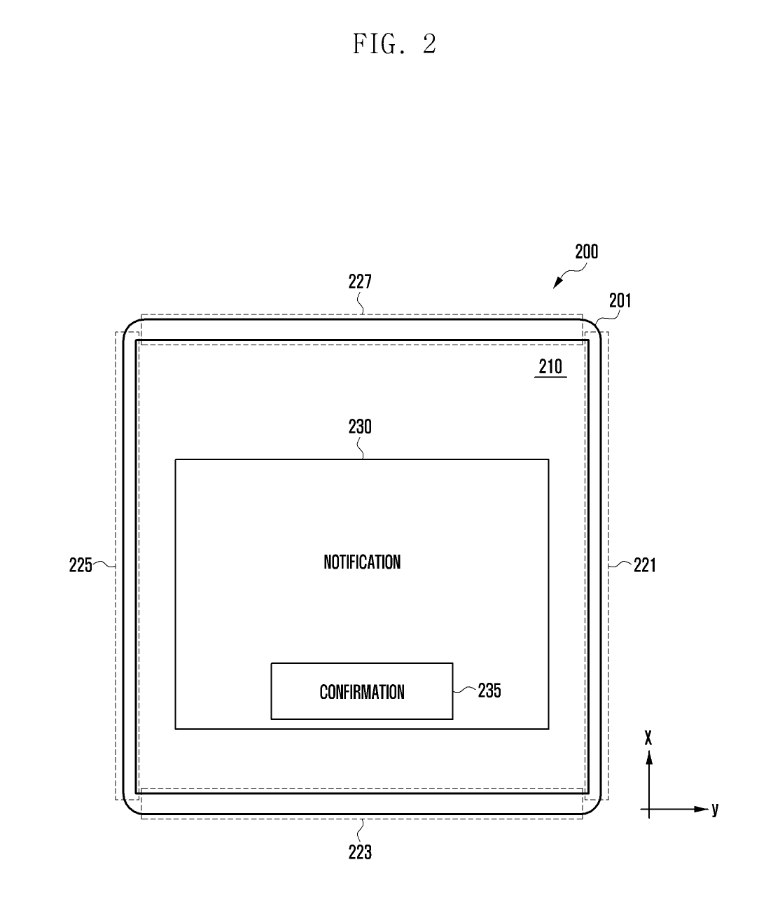

FIG. 2 illustrates an example of a user interface 200 provided by an electronic device (e.g., electronic device 110) according to various embodiments of the disclosure. Referring now to FIG. 2, the user interface 201 may be provided through, for example, at least a partial area (e.g., display unit 123) of the electronic device (e.g., electronic device 110) according to control of the providing module 111. The user interface 201 may include a display area 210 that provides to the user an application or information related to the application visually. Additionally or alternatively, the user interface 201 may include an outer area 221, 223, 225, 227 formed as a perimeter along at least part of the edge of the user interface 201 including corners of the display area 210. The outer area (221-227) may be, for example, a bezel area of electronic device (e.g., electronic device 110), and may have a certain width. FIG. 2 illustrates, for convenience of explanation, that user interface 201 has a rectangular shape in this one embodiment. However, according to some embodiments, the user interface 201 may be constructed of an irregularly shaped or a geometric figure (e.g., a circle, a triangle, a pentagon, or a hexagon) other than a rectangle, or some other form.

According to one embodiment of the present disclosure, as shown in FIG. 2, a notification application (or a notification function thereof) 230 may be provided to at least part of the display area 210 as application of interest. Further, the display area 210 may provide a confirmation menu 235 for acquiring the user's intent as one of the function of the notification application 230. The notification application 230 may provide a notification to user which provides user with a message received by the electronic device 110 through the network 130, a notification application which provides user with a warning message (e.g., a warning message about a remaining capacity of battery) from an internal system of the electronic device 110, or a notification application which notifies a state of the application to user by an application executed in the electronic device 110 (e.g., a dialog application). The confirmation function 235 may also be a function which is provided in order to confirm the intention of the user in a corresponding notification application.

The outer area 221-227 may be an area (e.g., an area which does not provide application, and the like to user) which does not provide visual information to user. According to some embodiments, the outer area 220 may include part of the display area 210. According to one embodiment of the present disclosure, for example, a first outer area 221 may include the right side of the display area 210, a second outer area 223 may include the lower side of the display area 210, a third outer area 225 may include the left side of the display area 210, and a fourth outer area 227 may include the upper side of the display area 210 respectively.

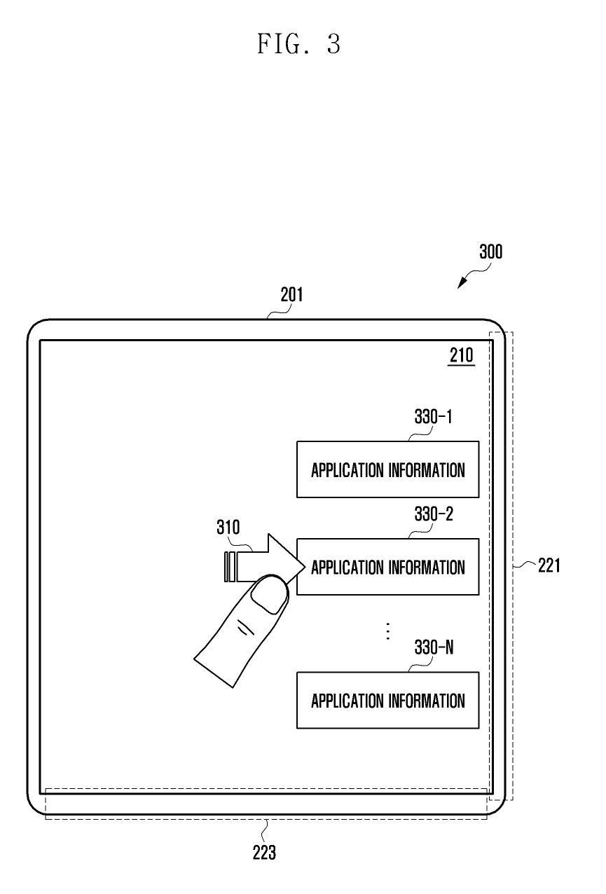

FIG. 3 illustrates an example of a user interface 300 provided by an electronic device (e.g., electronic device 110) according to various embodiments of this disclosure.

The display area 210 of the user interface 201 may provide specific information (e.g., time, date, or weather, etc.) at a given point in time, or information (e.g., notification application 230 or confirmation menu 235) related to an application of interest (shown in FIG. 2), or may not provide any information. After this, for example, according to user input related to application of interest (e.g., notification application 230 or confirmation menu 235), information 330-1 to 330-N related to at least one application (e.g., a candidate application) may be provided to user.

For example, when user input 310 is detected that moves to the right side or in a direction of outer area 221 (e.g., a first direction), information related to a candidate application (e.g., an email application, or video call application) which has been previously specified so as to correspond to the direction may be provided to the display area 210 of the user interface 201. Similarly, although not shown, when user input moves in an upper direction or in a direction of outer area 223 (e.g., a second direction), information related to another candidate application may be provided.

According to one embodiment of the present disclosure, information (e.g., application information 330-1 to 330-N) related to candidate application which is set according to movement direction of user input may be provided to various areas, for example, a central area, an upper area, or a left area of display area 210 regardless of an area corresponding to the direction of user input (e.g., right direction). For example, as the direction of movement of user input 310 faces toward the outer area 221 (e.g., right side) or toward the other outer area 223 (e.g., downward), information (e.g., application information 330-1 to 330-N) that is related to candidate application corresponding to the direction of movement of the user input may be displayed around the one outer area around 221 or the other outer area 223. According to some embodiments of the present disclosure, as the direction of the movement of the user input 310 faces toward the one outer area 221 (e.g., right side) or the other outer area 223 (e.g., downward), information (e.g., application information 330-1 to 330-N) related to candidate application may be displayed in a center or a top of the display area 210 regardless of the movement direction of user input. An artisan should understand and appreciate there can be more than the two outer area 221 and 223 discussed in this example.

At least one of the displayed information (e.g., application information 330-1 to 330-N) related to a candidate application may be selected by, for example, the user, and the selected candidate application may be identified as a target application. For example, among the information (e.g., application information 330-1) related to a first candidate application to the information (e.g., application information 330-N) related to an N-th candidate application, a second candidate application may be identified as a target application based on user input selecting information (e.g., application information 330-2) related to a second candidate application information.

Additionally or alternatively, the user interface 201 may display information related to a candidate application of each external device set correspondingly to attribute of user input. According to one embodiment of the present disclosure, when the direction of movement of the user input is in a first direction, the user interface 201 may display information related to at least one candidate application which can be executed in an external device 150-1 set correspondingly to the first direction. For example, referring to FIG. 2, when the user input which moves notification application 230 to the first direction (e.g., the outer area 221 side) is obtained, the user interface 201 may display information related to at least one application (e.g., message application or email application) executable in the first external device (e.g., external device 150-1) which is set so as to correspond to the direction. Similarly, when a user input which moves notification application 230 to a second direction (e.g., the outer area 223 side) is obtained, the user interface 201 may display information related to at least one application (e.g., video call application or voice call application) executable in a second external device (e.g., external device 150-2) which is set so as to correspond to the direction.

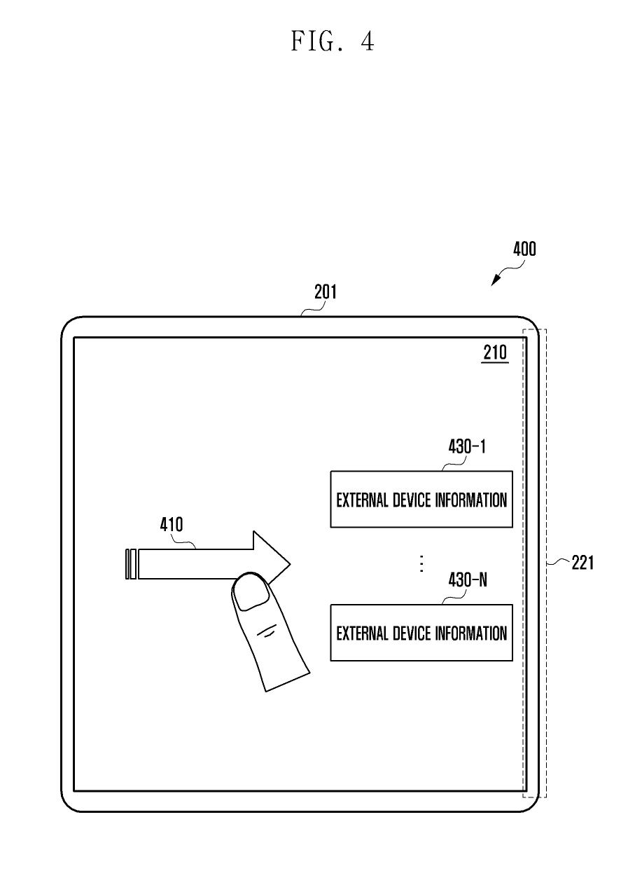

FIG. 4 illustrates an example of a user interface 300 (e.g., user interface 201) provided by an electronic device (e.g., electronic device 110) according to various embodiments of this disclosure.

According to one embodiment of the present disclosure, for example, when the user input that moves to a first direction (e.g., the right side or the outer area 221 side) with respect to the display area 210 is detected, the external device information 430-1 to 430-N related to an external device set correspondingly to the direction may be provided through the user interface 201. Similarly, although not shown, when the user input that moves to a second direction (e.g., the lower right direction) with respect to the display area 210 is detected, the external device information related to another external device set correspondingly to the lower right direction may be provided. According to one embodiment of the present disclosure, each of the external device information 430-1 to 430-N related to the external device may include attribute information (e.g., location information or status information) of a corresponding external device among external devices 150-1 to 150-N.

According to one embodiment of the present disclosure, at least the information related to an external device provided based on user input (or the attribute of the user input) may be selected, and the external device corresponding to the selected information may be an external device that executes a target application. For example, user input to select information related to at least one external device including information 430-1 related to external device among information 430-1 related to external device to information 430-N related to external device is obtained, the external device (e.g., 150-1) corresponding to information related to the selected external device may be identified as an external device that executes target application corresponding to application of interest. According to one embodiment of the present disclosure, a selection of specific information from among the external device information 430-1 to 430-N may be identified, for example, based on a context information such as status information of the electronic device (e.g., electronic device 110) which executes the application of interest, location information, or attribute information of the application of interest or candidate application, or use information.

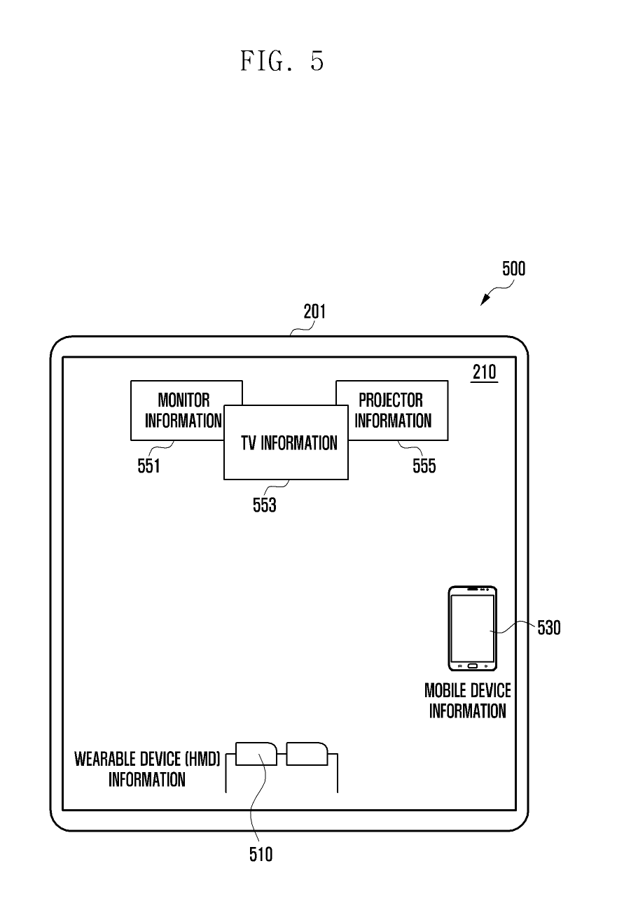

FIG. 5 illustrates an example of a user interface 500 (e.g., user interface 201) provided by an electronic device (e.g., electronic device 110) according to various embodiments of this disclosure.

According to one embodiment of the present disclosure, the information related to an electronic device (e.g., the electronic device 110 or at least one of the external devices 150-1 to 150-N) may be displayed in a different area of the display area 210 according to the attribute information of the electronic device. For example, when a given attribute of the electronic device is a first attribute, the information related to the electronic device may be displayed in a first area of the display area 210, and, when an attribute of the electronic device is a second attribute, the information related to the electronic device may be displayed in a second area of the display area 210 respectively.

According to one embodiment of the present disclosure, the attribute information may be an identifying type information regarding the electronic device (e.g., the electronic device 110 or at least one of the external devices 150-1 to 150-N). For example, when the electronic device is a wearable device (e.g., head mounted device (HMD)), the user interface 201 may display information 510 related to wearable device in a lower area of the display area 210. When the electronic device is a mobile device (e.g., a smart phone), the user interface 201 may display information 530 related to mobile device on the right side of the display area 210. Similarly, when the external device is a stationary device (e.g., a monitor, TV, or a projector), the user interface 201 may display information (e.g., monitor information 551, TV information 553 or projector information 555) related to stationary device on an upper area of the display area 210. Information related to each of a plurality of electronic devices may be separately displayed, or at least part of the information may be displayed to be overlapped with each other (e.g., monitor information 551, TV information 553, and projector information 555).

According to various embodiments of the present disclosure, the electronic device (e.g., electronic device 110) may include a providing module (e.g., providing module 111) to display a first application (e.g., an application of interest) to be executed in an electronic device, an acquisition module (e.g., acquisition module 113) to obtain user input corresponding to the providing module, an identification module (e.g., identification module 115) to identify a second application to be executed in an external device (e.g., at least one external device 150) for the electronic device based on the user input or at least one (e.g., a target application) of the second application function, and a generation module (e.g., generation module 117) to generate data provided to the external device based on the first application, the second application, or at least one of the function.

According to various embodiments of the present disclosure, the electronic device 110 may further include a setting module to set a display area which displays information related to the external device through the providing module, based on location information related to the external device or a signal strength received from the external device. According to various embodiments of the present disclosure, the first application may be provided along at least the X-axis direction or the Y-axis direction of the providing module, and the providing module may change the display area when the direction of providing the first application is changed in the setting module. According to various embodiments of the present disclosure, the electronic device may further include at least one communication module, and the setting module may identify distance information between the electronic device and the external device based on a signal strength received to the at least one communication module from the external device, and may set a display area which displays information related to the external device through the providing module based on the distance information.

According to various embodiments of the present disclosure, the providing module may display information (e.g., candidate application information) on the display unit related to at least one application or a function thereof. According to various embodiments of the present disclosure, the providing module may provide information related to the external device operatively coupled to the electronic device.

According to various embodiments of the present disclosure, the providing module may set location so that information corresponding to the external device is differently displayed on the display unit based on location information of the external device.

According to various embodiments of the present disclosure, the providing module may provide information related to at least a first external device when an attribute of the user input is a first attribute, and may provide information related to at least a second external device when an attribute of the user input is a second attribute.

According to various embodiments of the present disclosure, the identification module may select the second application by using information related to the at least one application or a function thereof based on the user input.

According to various embodiments of the present disclosure, when the user input is a gesture, the identification module may identify application corresponding to the gesture as the second application.

According to various embodiments of the present disclosure, the identification module may identify another application as the second application according to at least one of a type, a direction, an intensity, or a time of the user input.

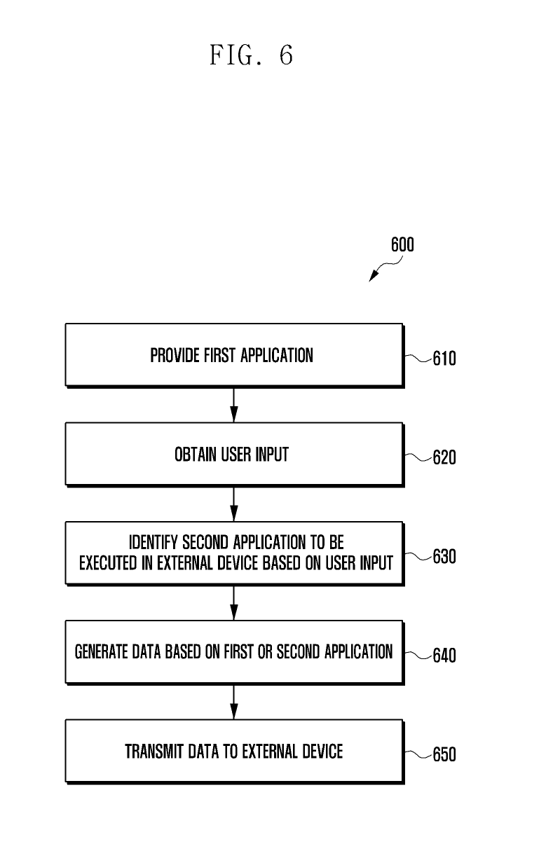

FIG. 6 is a flowchart 600 illustrating exemplary operation of a method for providing an application by using an electronic device (e.g., electronic device 110) according to various embodiments of the present disclosure.

At operation 610, the electronic device (e.g., providing module 111) may provide, for example, a first application (e.g., application of interest) through a display unit (e.g., display unit 123). The first application may be any application (e.g., a phone, a video call, an e-mail, a camera, an image viewer, or an instant messaging, etc.) that can be performed in the electronic device, or may be a partial function thereof. At operation 620, the electronic device (e.g., acquisition module 113) may obtain a user input related to the first application. The electronic device may obtain a user input related to the first application, for example, at least one of: a user input to move at least part of the first application, a user input to select a candidate application displayed in relation to the first application, or a user input to select information related to at least one external device 150 displayed in relation to the first application. The user input may include a user's gesture detected in a surface of display unit (e.g., display unit 123) or its proximity operatively coupled to the electronic device (e.g., electronic device 110). The user gesture may include a movement (or intention) of the user represented by a part of the body (e.g., a hand, a face, or an eye), an input means such as a stylus, or a combination thereof.

At operation 630, the electronic device (e.g., identification module 115) may identify a second application (e.g., a target application) to be executed in an external device (e.g., at least one external device 150) which is operatively coupled to the electronic device based on the user input. For example, the second application may be any application (e.g., a phone, a video call, an e-mail, a camera, an image viewer, or an instant messaging, etc.) that can be executed in the external device. According to one embodiment of the present disclosure, the second application may be any application different from the first application, or may be a second function of the first application different from a first function of the first application performed in the electronic device.

At operation 640, the electronic device (e.g., generation module 117) may generate data that will be provided to at least one external device 150 from an electronic device (e.g., electronic device 110), based on at least one of the first application (e.g., application of interest) or the second application (e.g., a target application). At operation 650, the electronic device (e.g., generation module 117) may transmit the generated data to the external device (e.g., at least one external device 150). In this case, the external device may execute the second application or a partial function thereof by using the (received) data, subsequently to the first application which was executed in the electronic device (e.g., electronic device 110) or a partial function thereof.

According to one embodiment of the present disclosure, the electronic device may obtain information (e.g., a second image) related to the processing of the data (e.g., a first image and an instruction) from the external device. In this case, the electronic device may execute at least one application (e.g., image viewer application) by using the data. The above operations may be executed by any of a sequential, a parallel, an iterative, or a heuristic method, just to name some non-limiting possibilities. In addition, some operations may be executed in a different order, or omitted, or may add other operation.

According to various embodiments of the present disclosure, the method of providing an application may include an operation of providing a first application (e.g., application of interest) through a display unit (e.g., display unit 123) operatively coupled to an electronic device (e.g., electronic device 110), an operation of obtaining a user input related to the first application, an operation of identifying a second application (e.g., a target application) to be executed in an external device (e.g., at least one external device 150) for the electronic device based on the user input, and an operation of generating data which will be provided to the external device from the electronic device based on at least one of the first application or the second application.

According to various embodiments of the present disclosure, the operation of identifying may include an operation of displaying information (e.g., information related to candidate application) related to at least one application function or a function thereof on the display unit (e.g., providing module 111), and an operation of selecting the second application by using information related to the at least one application or a function thereof based on the user input.

According to various embodiments of the present disclosure, the operation of identifying may include an operation of determining at least one direction of movement relating to the user input and an operation of displaying information related to an application (e.g., a candidate application) or an external device corresponding to each of the at least one direction of movement through the display unit.

According to various embodiments of the present disclosure, the operation of identifying may include at least one of an operation of displaying information related to at least a third application when at least part of the first application moves to a first area of the electronic device according to the user input or an operation of displaying information related to at least a fourth application when at least part of the first application moves to a second area of the electronic device according to the user input.

According to various embodiments of the present disclosure, at least one of the first area or the second area may include a bezel. According to various embodiments of the present disclosure, the operation of identifying may include an operation of identifying an application corresponding to a gesture as the second application when the user input is the gesture. According to various embodiments of the present disclosure, the operation of identifying may include the operation of identifying another application as the second application according to at least one of a type, a direction, an intensity, or a time of the user input.

According to various embodiments of the present disclosure, the operation of identifying may include an operation of providing device information related to at least one external device (e.g., external devices 150-1 and 150-2) operatively coupled to the electronic device, an operation of selecting at least partial information from among the device information based on the user input, and an operation of selecting a device corresponding to the at least partial information as the external device.

According to various embodiments of the present disclosure, the operation of providing device information related to the at least one external device (e.g., external devices 150-1 and 150-2) may include an operation of providing information related to at least a first external device when the direction of movement of the user input is a first direction, and an operation of providing information related to at least a second external device when the direction of movement of the user input is a second direction.

According to various embodiments of the present disclosure, the operation of providing device information related to the at least one external device may include an operation of providing information related to at least a first external device when an attribute of the user input is a first attribute, and an operation of providing information related to at least a second external device when an attribute of the user input is a second attribute.

According to various embodiments of the present disclosure, the operation of identifying may include an operation of determining at least one movement direction relating to the user input and an operation of identifying a preset application or external device corresponding to the at least one movement respectively as the second application or an external device in which the second application is to be executed.

According to various embodiments of the present disclosure, the operation of generating may include an operation of including information processed by the first application in the data so that the first application may be processed subsequently in the external device.

According to various embodiments of the present disclosure, when the electronic device obtains process information related to the data from the external device, it may further include an operation of executing at least one application by using the electronic device.

According to various embodiments of the present disclosure, it may further include an operation of obtaining location information of the external device and an operation of setting an attribute of the user input corresponding to the external device based on the location information.

According to various embodiments of the present disclosure, it may further include an operation of obtaining location information related to the external device and an operation of setting a location so that information corresponding to the external device may be differently displayed on the display unit based on the location information.

According to various embodiments of the present disclosure, it may further include an operation of setting a location displaying at least one of information corresponding to the external device or information related to application of the external device on the display unit, based on at least one of hardware configuration information of the external device, software configuration information, or state information.

According to various embodiments of the present disclosure, it may further include an operation of obtaining information of signal strength received from the external device and an operation of setting a location so that information corresponding to the external device may be differently displayed on the display unit based on the information of signal strength.

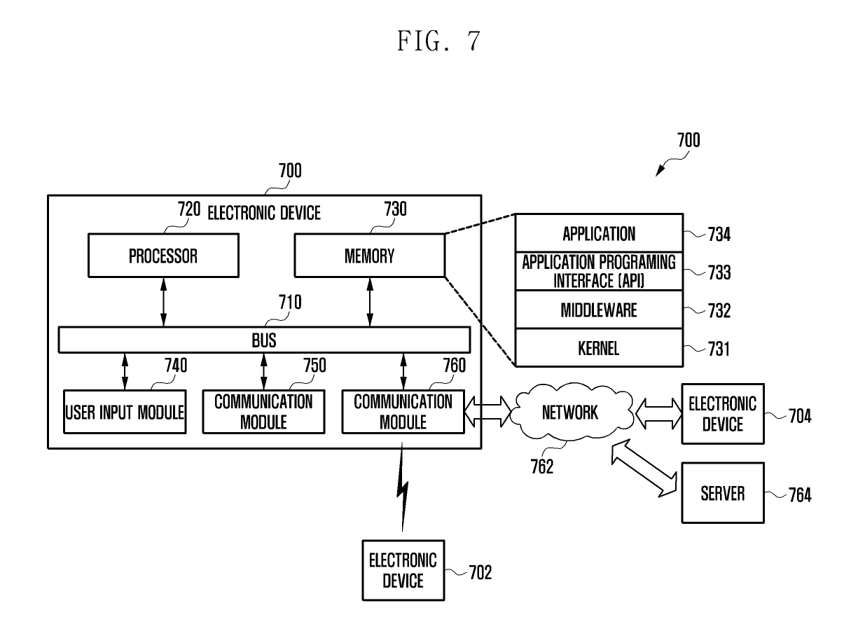

FIG. 7 illustrates a block diagram 700 for an electronic device 701 according to various embodiments of the present disclosure.

According to one embodiment of the present disclosure, an electronic device 701 may correspond to the electronic device 110 of FIG. 1. Referring now to FIG. 7, the electronic device 701 may include a bus 710, a processor 720, a memory 730, a user input module 740, a display module 750, or a communications module 760.

The bus 710 may be a circuit that interconnects aforementioned elements, and transfers a communication (e.g., control message) between the aforementioned elements. The processor 720 (e.g., process 121) may, for example, receive a command from the aforementioned other elements (e.g., the memory 730, the user input module 740, the display module 750, the communication module 760, etc.) through the bus 710, decode the received command, and may execute an operation or a data processing according to the decoded command.

The memory 730 (e.g., memory 125) may store the command or data received from the processor 720 or other elements (e.g., the user input module 740, the display module 750, the communication module 760, etc.) or generated by the processor 720 or other elements. The memory 730 may include, for example, a programming module such as a kernel 731, a middleware 732, an application programming interface (API) 733, or an application 734. Each of the aforementioned programming modules are hardware that may be configured by a software, firmware, just hardware, or a combination of them.

The kernel 731 may control or manage system resources (e.g., the bus 710, the processor 720 or the memory 730, etc.) used to execute an operation or a function implemented in the other programming modules, for example, the middleware 732, the API 733 or the application 734. In addition, the kernel 731 may provide an interface that enables the middleware 732, the API 733 or the application 734 to access to an individual element of the electronic device 701 to control or manage.

The middleware 732 may perform a role of intermediary so that the API 733 or the application 731 may communicate with the kernel 734 to send and receive data. In addition, the middleware 732 may perform load balancing for a task request with respect to task requests received from the (multiple) applications 734, by using a method, for example, of assigning a priority to at least one application among the (multiple) applications 734 to use system resource (e.g., the bus 710, the processor 720, or the memory 730, etc.) of the electronic device 701.

The API 733 is an interface which enables the application 734 to control the function provided by the kernel 731 or the middleware 732, and may include at least one interface or a function such as a file control, a window control, an image processing, or a character control.

The user input module 740 may receive a command or data from, for example, a user to send to the processor 720 or the memory 730 through the bus 710. The display module 750 (e.g., display unit 123) may display an image, a video or data, and the like to the user.

The communication module 760 may connect communications between the electronic device 701 and other electronic device 702 or 704, or between the electronic device 701 and the server 764. The communication module 760 may support a certain short range communication protocol (e.g., wireless fidelity (WiFI), Bluetooth (BT), near field communication (NFC)) or a certain network communication (e.g., Internet, local area network (LAN), wire area network (WAN), telecommunication network, cellular network, satellite network, or plain old telephone service (POTS), etc.) 762. The electronic devices 702, 704 may be the same (e.g., the same type) device as the electronic device 701 or other (e.g., different type) device, respectively.

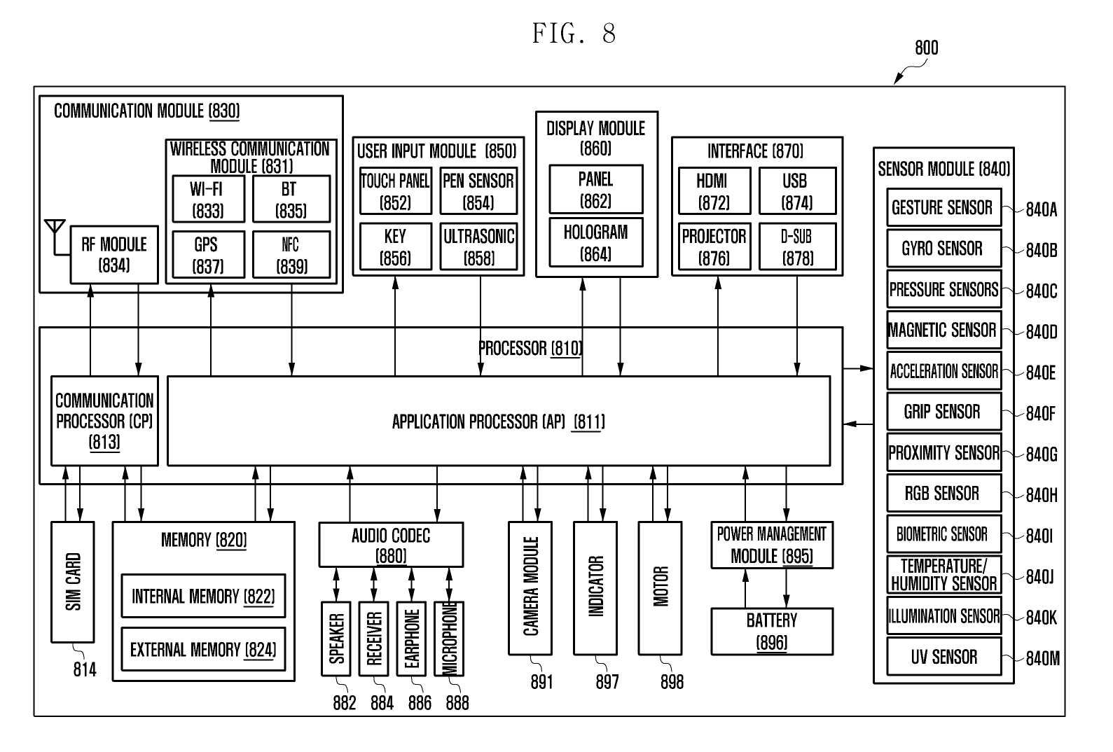

FIG. 8 illustrates a block diagram of a hardware 800 according to various embodiments of the present disclosure.

The hardware 800 may form, for example, an entire or part of the electronic device 701 illustrated in FIG. 7. Referring now to FIG. 8, the hardware 800 may include one or more processors 810, a subscriber identification module (SIM) card 814, a memory 820, a communication module 830, a sensor module 840, a user input module 850, a display module 860, an interface 870, an audio codec 880, a camera module 891, a power management module 895, a battery 896, an indicator 897 or a motor 898.

The processor 810 (e.g., the processor 720) may include one or more application processor (AP) 811, or one or more communication processors (CP) 813. The processor 810 may be, for example, the processor 720 illustrated in FIG. 7. FIG. 8 illustrates that the AP 811 and the CP 813 are included in the processor 810, but the AP 811 and the CP 813 may be included in a different IC package. According to one embodiment of the present disclosure, the AP 811 and the CP 813 may be included in a single IC package.

The AP 811 may control a plurality of hardware or software elements connected to the AP 811 by driving an operating system or an application program, and may perform various data processing and calculation including multimedia data. The AP 811 may be implemented by, for example, a system on chip (SoC). According to one embodiment of the present disclosure, the processor 810 may further include a graphic processing unit (GPU) (not shown).

The CP 813 may perform a function of managing a data link and converting a communication protocol in a communication between an electronic device (e.g., the electronic device 701) including the hardware 800 and other electronic devices connected by the network. The CP 813 may be implemented by, for example, a SoC. According to one embodiment of the present disclosure, the CP 813 may perform at least part of multimedia control function. The CP 813 may perform a distinction and an authentication of a terminal in a communication network by using, for example, a subscriber identification module (e.g., SIM card 814). Moreover, the CP 813 may provide services such as a voice call, a video call, a text message, or a packet data to the user. Further, the CP 813 may control a data transmission and reception of the communication module 830. FIG. 8 illustrates that the CP 813, the elements such as the power management module 895 or the memory 820 is separated from the AP 811, but, according to one embodiment of the present disclosure, the AP 811 may be implemented to include at least part (e.g., the CP 813) of the aforementioned elements.

According to one embodiment of the present disclosure, the AP 811 or the CP 813 may load and process the command or data received from at least one of respectively connected non-volatile memory or other element in a volatile memory. Furthermore, the AP 811 or the CP 813 may store data received from at least one of other elements or generated by at least one of other elements in a non-volatile memory.

The SIM card 814 may be a card implementing a subscriber identification module, and may be inserted into a slot formed in a specific position of the electronic device. The SIM card 814 may include unique identification information (e.g., integrated circuit card identifier (ICCID)) or subscriber information (e.g., international mobile subscriber identity (IMSI)).

The memory 820 may include an internal memory 822 or an external memory 824. The memory 820 may be, for example, a memory 730 illustrated in FIG. 7. The internal memory 822 may include, for example, at least one of a volatile memory (e.g., a dynamic RAM (DRAM), a static RAM (SRAM), synchronous dynamic RAM (SDRAM), etc.) or a non-volatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.). According to one embodiment of the present disclosure, the internal memory 822 may be configured in the form of a Solid State Drive (SSD). The external memory 824 may further include a flash drive, for instance, a compact flash (CF), a secure digital (SD), micro secure digital (Micro-SD), mini secure digital (Mini-SD), extreme digital (xD) or Memory Stick, just to name some non-limiting examples.

The communication module 830 may include a wireless communication module 831 or a RF module 834, or both. The communication module 830 may be, for example, the communication module 760 illustrated in FIG. 7. The wireless communication module 831 may include, for example, a WiFi 833, a Bluetooth (BT) 835, a GPS 837 or a near field communication (NFC) 839. For example, the wireless communication module 831 may provide a wireless communication function by using a radio frequency. Additionally or alternatively, the wireless communication module 831 may include a network interface (e.g., LAN card) or a modem, and the like which enables the hardware 800 to connect to a network (e.g., Internet, local area network (LAN), wire area network (WAN), telecommunication network, cellular network, satellite network, or plain old telephone service (POTS), and the like).

The RF module 834 may perform a data transmission, for example, a transmission and reception of a RF signal or a called electronic signal. The RF module 834 may include, although not shown, for example, a transceiver, a power amp module (PAM), a frequency filter or a low noise amplifier (LNA), and the like. In addition, the RF module 834 may further include a component to transmit and receive electromagnetic waves in free space in a wireless communication, for example, a conductor or a conducting wire, and the like.

The sensor module 840 may include, for example, at least one of a gesture sensor 840A, a gyro sensor 840B, a pressure sensors 840C, a magnetic sensor 840D, an acceleration sensor 840E, a grip sensor 840F, a proximity sensor 840G, a red-green-blue (RGB) sensor 840H, a biometric sensor 840I, a temperature/humidity sensor 840J, an illumination sensor 840K, or an ultra violet (UV) sensor 840M. The sensor module 840 may measure a physical quantity or sense an operating state of the electronic device, and convert the measured or sensed information into an electrical signal.

Additionally/alternatively, the sensor module 840 may include, for example, an E-nose sensor (not shown), an electromyography sensor (EMG sensor) (not shown), an electroencephalogram sensor (EEG sensor) (not shown), an electrocardiogram sensor (ECG sensor) (not shown), or a fingerprint sensor, and the like. The sensor module 840 may further include a control circuit to control at least one sensor included therein.

The user input module 850 may include a touch panel 852, a (digital) pen sensor 854, a key 856 or an ultrasonic input device 858. The user input module 850 may be, for example, the user input module 740 illustrated in FIG. 7. The touch panel 852 may recognize a touch input by, for example, at least one of a capacitive, a resistive, an infrared or an ultrasonic type. In addition, the touch panel 852 may further include a controller (not shown). In the case of a capacitive type, a proximity recognition as well as a direct touch can be used. The touch panel 852 may further include a tactile layer. In this case, the touch panel 852 may provide user with a tactile response.

The (digital) pen sensor 854 may be implemented, for example, by utilizing a method identical or similar to a method of receiving a user's touch input or using a separate sheet for recognition. As the key 856, for example, a keypad or a touch key may be used. The ultrasonic input device 858 may determine data by sensing a sound wave by a microphone (e.g., microphone 888) in a terminal through a pen that generates an ultrasonic signal, and may be implemented in a wireless recognition type. According to one embodiment of the present disclosure, the hardware 800 may receive, by using the communication module 830, a user input from an external device (e.g., a network, a computer, or a server) connected to the communication module 830.

The display module 860 may include a panel 862 or a hologram 864. The display module 860 may be, for example, the display module 750 illustrated in FIG. 7. The panel 862 may be, for example, a liquid-crystal display (LCD) or an active-matrix organic light-emitting diode (AM-OLED), or the like. The panel 862 may be implemented, for example, in a flexible, a transparent, or a wearable type. The panel 862 and the touch panel 852 may be configured as a single module. The hologram 864 may display a three-dimensional image in the air by using interference of light. According to one embodiment of the present disclosure, the display module 860 may further include a control circuit to control the panel 862 or the hologram 864.

The interface 870 may include, for example, a high-definition multimedia interface (HDMI) 872, a universal serial bus (USB) 874, a projector 876 or a D-subminiature (D-sub) 878. Additionally or alternatively, the interface 870 may include, for example, a secure Digital (SD)/a multi-media card (MMC) (not shown) or an infrared data association (IrDA) (not shown).

The audio codec 880 may convert a voice and an electric signal bidirectionally. The audio codec 880 may convert, for example, voice information received or outputted through a speaker 882, a receiver 884, an earphone 886 or a microphone 888, and the like.

The camera module 891 is a device to capture a video and an image, and, according to one embodiment of the present disclosure, may include one or more image sensors (e.g., a front lens or a rear lens), an image signal processor (ISP) (not shown) or a flash LED (not shown).

The power management module 895 may manage a power of the hardware 800. Although not shown, the power management module 895 may include, for example, a power management integrated circuit (PMIC), a charger integrated circuit (a charger IC), or a battery fuel gauge.

The PMIC may be mounted, for example, in an integrated circuit or a SoC semiconductor. The charging method may be divided into wired and wireless types. The charger IC may charge a battery, and may prevent an over-voltage or over-current flow from a charger. According to one embodiment of the present disclosure, the charger IC may include a charger IC for at least one of a wired charging mode or a wireless charging mode. The wireless charging mode may include, for example, a magnetic resonance method, a magnetic induction method, or an electromagnetic wave method, and the like, and may add an additional circuitry for a wireless charging, such as a coil loop, a resonant circuit, a rectifier, and the like.

The battery fuel gauge may measure, for example, the remains of the battery 896, charged voltage, current or temperature. The battery 896 may generate electricity to supply a power, for example, and may be a rechargeable battery.

The indicator 897 may display a specific state of the hardware 800 or part (e.g., the AP 811) of the hardware 800, for example, a booting state, a message state or a charging state. The motor 898 may convert an electrical signal into a mechanical vibration. The MCU 899 may control the sensor module 840.

Although not shown, the hardware 800 may include a processing unit (e.g., GPU) for a support of mobile TV. The processing unit for a support of mobile TV may process, for example, a media data in accordance with a standard such as a digital multimedia broadcasting (DMB), a digital video broadcasting (DVB) or a media flow, etc. Each of the aforementioned elements of the hardware according to the present disclosure may be configured by one or more components, and the name of corresponding element may be changed depending on the kind of electronic device. The hardware according to the present disclosure may be configured to include at least one of the above-described elements, and may omit some elements or may further include additional other element. Further, some of the hardware elements according to the present disclosure may be combined to configure a single entity, so that it may perform the function of corresponding elements prior to combination in the same manner.

A module may be interchangeably used by a term, such as a unit, a logic, a logical block, a component, or a circuit, and the like. The module may be a minimum unit of an integrally configured component or part of it. The module may be a minimum unit that performs one or more functions or part of it. The module may be implemented mechanically or electronically. For example, a module according to the present disclosure may include at least one of, known or to be developed in the future, an application-specific integrated circuit (ASIC) chip performing certain operations, a field-programmable gate arrays (FPGAs), or a programmable logic device.

According to various embodiments of the present disclosure, at least part of a device (e.g., modules or functions thereof) or a method (e.g., operations) according to the present disclosure be implemented, for example, by an instruction stored in a computer-readable storage media in a form of a programming module. When the instruction is executed by at least one processor (e.g., the processor 810), the at least one processor may perform a function corresponding to the instruction. The computer readable storage media may be, for example, the memory 860. At least part of the programming module may be implemented (e.g., executed) by, for example, the processor 810. At least part of the programming module may include, for example, a module, a program, a routine, sets of instructions and/or a process, or the like to perform one or more functions.

The programming module according to the present disclosure may include at least one of the aforementioned elements, or may omit a part of the aforementioned elements, or may further include additional different elements. The operations performed by the programming module according to the present disclosure or other elements may be executed by a sequential, a parallel, an iterative, or a heuristics method. In addition, some operations may be executed in a different order, or may be omitted, or may add other operations.

The apparatuses and methods of the disclosure can be implemented in hardware, and in part as firmware or via the execution of software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor, controller, control unit or other programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” or “microcontroller” constitute hardware in the claimed disclosure that contain circuitry that is configured for operation with software or firmware. Under the broadest reasonable interpretation, the appended claims constitute statutory subject matter in compliance with 35 U.S.C. §101.

The definition of the terms “unit” or “module” as referred to herein is to be understood as constituting hardware circuitry such as a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and does not constitute software per se or pure software.

The computer-readable storage media may include Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as Read Only Memory (ROM), Random Access Memory (RAM), or flash memory for storing and executing program commands (e.g., a programming module). Further, the program command may include a machine language code created by a compiler and a high-level language code executable by a computer using an interpreter. The foregoing hardware device may be configured to be operated according to at least one software module to perform an operation of the present disclosure, or software modules may be configured to be operated according to the hardware device.

According to various embodiments of the present disclosure, the computer readable storage media may record a program for executing an operation to obtain an user input related to a first application provided through a display unit operatively coupled to the electronic device 110, an operation to identify a second application which will be executed in an external device 150 for the electronic device 110 based on the user input, and an operation to generate data to be provided to the external device 150 from the electronic device 110 based on at least one of the first application or the second application.

A method and an apparatus for providing an application according to various embodiments of the present disclosure may provide the application, for example, through a plurality of electronic devices, and may provide the application to a user through a device suitable for the technological attributes of attribute.

In addition, a method and an apparatus for providing an application according to various embodiments of the present disclosure may select, for example, an electronic device executing an application based on attribute information of a plurality of electronic devices, and may provide an intuitive method selecting the electronic device.

Although embodiments of the present disclosure have been described in detail hereinabove, it should be clearly understood that many variations and modifications of the basic inventive concepts herein taught which may appear to those skilled in the present art will still fall within the spirit and scope of the present disclosure, as defined in the appended claims.

What is claimed is:

1. A method comprising:
providing by providing processor a first application through a display unit operatively coupled to an electronic device;
in response to obtaining an input related to the first application, identifying by an identification processor a second application to be executed in an external device for the electronic device based on the input; and
generating by a generating processor data to be provided to the external device from the electronic device based on at least one of the first application or the second application.

2. The method of claim 1, wherein the identifying of the second application comprises:
displaying information related to at least one of the first application or the second application or a function thereof on the display unit; and
selecting the second application by using the information related to at least one of the first application or the second application or a function thereof based on the input.

3. The method of claim 1, wherein the identifying of the second application comprises:
identifying at least one direction of movement related to the input; and
displaying by the display unit information related to an application or an external device respectively corresponding to the at least one direction of movement along the display unit.

4. The method of claim 1, wherein the identifying of the second application comprises at least one of:
displaying information related to at least a third application, when at least a part of the first application being displayed moves to a first area of the electronic device according to the input; or
displaying information related to at least a fourth application, when at least part of the first application moves being displayed to a second area of the electronic device according to the input.

5. The method of claim 4, wherein at least one of the first area or the second area includes a bezel.

6. The method of claim 1, wherein the identifying of the second application comprises, when the input is a gesture, identifying an application corresponding to the gesture as the second application.

7. The method of claim 1, wherein the identifying of the second application comprises identifying another application as the second application, according to at least one of a type, a direction, a pressure of input, or a time of the input.

8. The method of claim 1, wherein the identifying of the second application comprises:
providing device information related to at least one external device operatively coupled to the electronic device;
selecting at least a part of the device information based on the input; and
selecting a device corresponding to the part of the device information as the external device.

9. The method of claim 8, wherein the providing of the device information related to at least one external device comprises:
providing information related to at least a first external device, when an attribute of the input is a first attribute; and
providing information related to at least a second external device, when an attribute of the input is a second attribute.

10. The method of claim 1, wherein the identifying of the second application comprises:
determining at least one direction of movement related to the input; and
identifying a preset application or external device corresponding to each of the at least one direction of movement as the second application or an external device in which the second application is to be executed.

11. The method of claim 1, wherein the generating of the data comprises including information processed by the first application in the data so that the first application is processed subsequently in the external device.

12. The method of claim 1, further comprising executing at least one application by using the electronic device, when the electronic device obtains processing information related to the data from the external device.

13. The method of claim 1, further comprising:
obtaining location information of the external device; and
setting an attribute of the input corresponding to the external device based on the location information.

14. The method of claim 1, further comprising:
obtaining location information related to the external device; and
setting a location so that information corresponding to the external device is differently displayed in the display unit based on the location information.

15. The method of claim 1, further comprising:
setting a location that displays at least one of information corresponding to the external device or information related to an application of the external device in the display unit, based on at least one of hardware configuration information, software configuration information, or state information of the external device.

16. An electronic device comprising:
a display unit;
at least one processor configured to:
provide to the display unit a first application to be executed in an electronic device;
obtain a user input corresponding to the provide first application;
identify at least one of a second application to be executed in an external device for the electronic device or a function of the second application based on the user input; and
generate data to be provided to the external device based on at least one of the first application, the second application, or the function.

17. The electronic device of claim 16, further wherein the at least one processor is further configured to set a display area of the display unit that displays information related to the external device, based on location information for the external device or a signal strength received from the external device.

18. The electronic device of claim 17, wherein the first application is provided at least along an X-axis direction or a Y-axis direction of the at least one processor providing the first application, and the at least one processor is set to change the display area, when a direction of providing the first application is changed.

19. The electronic device of claim 17, further comprising at least one communication processor, and the at least one processor is configured to identify distance information between the electronic device and the external device, based on a signal strength received to the at least one communication processor from the external device, and set a display area that displays information related to the external device, based on the distance information.

20. A computer-readable recording non-transitory medium having recorded a program that when executed by a processor that is configured for
obtaining an input related to a first application provided through a display unit operatively coupled to an electronic device;
identifying a second application to be executed in an external device for the electronic device based on the input; and
generating data to be provided to the external device from the electronic device based on at least one of the first application or the second application.
